(19) United States
(12) Patent Application Publication
(10) Pub. No.: US 2015/0242065 A1
(43) Pub. Date: Aug. 27, 2015

(54) METHOD AND APPARATUS FOR DISPLAYING SCREEN ON ELECTRONIC DEVICE

(71) Applicant: Samsung Electronics Co., Ltd., Gyeonggi-do (KR)

(72) Inventors: Kwanghyun KO, Gyeonggi-do (KR); Doosuk KANG, Gyeonggi-do (KR); Yonghak PARK, Gyeonggi-do (KR); Youngsu LEE, Gyeonggi-do (KR); Woojin JEONG, Seoul (KR); Junhee CHO, Gyeonggi-do (KR)

(73) Assignee: Samsung Electronics Co., Ltd.

(21) Appl. No.: 14/628,924

(22) Filed: Feb. 23, 2015

(30) Foreign Application Priority Data
Feb. 21, 2014 (KR) 10-2014-0020905

(51) Int. Cl. G06F 3/0481; G09G 5/38; G06F 3/0488; G09G 5/14; G06F 3/0482; G06F 3/0484

(52) U.S. Cl. CPC G06F 3/0481; G06F 3/0482; G06F 3/04817; G06F 3/04847; G06F 3/04886; G09G 5/14; G09G 5/38; G09G 2354/00; G09G 2340/0464; G09G 2320/08; G09G 2340/14

(57) ABSTRACT

Disclosed is a screen display method, including recognizing a request for displaying a size-adjusted screen, displaying the size-adjusted screen on one region of a display unit in response to the request, and displaying an auxiliary screen on an outside region of the size-adjusted screen.

### PRIORITY

This application claims priority under 35 U.S.C. §119(a) to a Korean Patent Application filed on Feb. 21, 2014 in the Korean Intellectual Property Office and assigned Ser. No. 10-2014-0020905, the contents of which are incorporated herein by reference.

### BACKGROUND OF THE INVENTION

1. Field of the Invention

The present invention relates generally to a method and apparatus for displaying a screen, and more particularly, for displaying a screen with adjusted size on an electronic device and for utilizing an outside region of the sized-adjusted screen.

2. Description of the Related Art

As the amount of contents in electronic devices has increased, user preference for a large-sized screen has also increased, so that the contents can be more conveniently manipulated. To meet this demand, the screen of portable electronic devices has increased in size. For example, tablet Personal Computers (PCs) have been produced in a variety of screen sizes, and have promoted the popularization of electronic devices having a large-sized screen.

While such electronic devices support the use of many contents through the large-sized screen, the increased screen size has made it more difficult for users to manipulate the electronic devices, particularly with regard to viewing content on the screen.

As such, there is a need in the art for a method and apparatus that simplifies the display of content on electronic devices with larger-sized screens.

### SUMMARY OF THE INVENTION

The present invention has been made to address the above mentioned problems and disadvantages, and to provide at least the advantages described below.

Accordingly, an aspect of the present invention is to provide a function to display a size-adjusted screen in certain circumstances, thus promoting an easy manipulation of an electronic device having a large-sized screen.

Another aspect of the present invention is to provide a method and apparatus that promotes the execution of functions using an outside region of a size-adjusted screen, thus maximizing the utilization capacity of an electronic device.

In accordance with an aspect of the present invention, a screen display method of an electronic device includes recognizing a request for displaying a size-adjusted screen, and displaying the size-adjusted screen on one region of a display unit in response to the request, and displaying an auxiliary screen on an outside region of the size-adjusted screen, the outside region being outside of a perimeter of the size-adjusted screen.

In accordance with another aspect of the present invention, a screen display apparatus of an electronic device includes a display unit configured to display a size-adjusted screen changed from a full screen of the electronic device and to display an auxiliary screen in an outside region of the size-adjusted screen, and a control unit configured to recognize a request for displaying the size-adjusted screen and, based on the request, to control the display unit to display the size-adjusted screen and the auxiliary screen.

In accordance with another aspect of the present invention, disclosed is a non-transitory computer-readable storage medium having recorded thereon a program for executing a screen display method of an electronic device, which includes recognizing a request for displaying a size-adjusted screen, and displaying the size-adjusted screen on one region of a display unit in response to the request, and displaying an auxiliary screen on an outside region of the size-adjusted screen, the outside region being outside of a perimeter of the size-adjusted screen.

### BRIEF DESCRIPTION OF THE DRAWINGS

The above and other aspects, features, and advantages of the present invention will be more apparent from the following detailed description taken in conjunction with the accompanying drawings, in which:

FIG. 1 illustrates a network environment including an electronic device in accordance with embodiments of the present invention;

FIG. 2 is a block diagram illustrating a basic configuration of an electronic device in accordance with an embodiment of the present invention;

FIG. 3 illustrates a screen display process in accordance with an embodiment of the present invention;

FIGS. 4A-4B, 5A-5C, 6A-6C, and 7A-7F are screenshots illustrating operations of adjusting a screen in accordance with embodiments of the present invention; and

FIG. 8 is a block diagram illustrating an electronic device in accordance with embodiments of the present invention.

### DETAILED DESCRIPTION OF EMBODIMENTS OF THE INVENTION

The present invention will be described with reference to the accompanying drawings. In the drawings, the same or similar elements are denoted by the same reference numerals even though they are depicted in different drawings. In the following description, a detailed description of known functions and configurations incorporated herein will be omitted for the sake of clarity and conciseness.

The expressions such as “include” and “may include” which may be used in embodiments of the present invention denote the presence of the disclosed functions, operations, and constituent elements and do not limit additional functions, operations, and constituent elements. Additionally, in embodiments of the present invention, the terms such as “comprise”, “include”, and/or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

Herein, the expression “or” includes any and all combinations of the associated listed words. For example, the expression “A or B” may include A, may include B, or may include both A and B.

In embodiments of the present invention, expressions including ordinal numbers, such as “first” and “second,” and/or the like, modify certain elements. However, such elements are not limited by the above expressions. For example, the above expressions do not limit the sequence and/or importance of the elements. The above expressions are used merely for the purpose to distinguish an element from the other elements. For example, a first user device and a second user device indicate different user devices although both of them the first user device and the second user device are user devices. For example, a first element may be referred to as a second element, and similarly, a second element may be also referred to as a first element without departing from the scope of the present invention.

When a component is referred to as being “connected” or “accessed” to another component, it should be understood that there may exist another component between the component and the another component. When a component is referred to as being “directly connected” or “directly accessed” to another component, it should be understood that there is no component between the two components.

The terms used in the present invention are only used to describe specific embodiments, and are not intended to limit the present invention. As used herein, the singular forms are intended to include the plural forms as well, unless the context clearly indicates otherwise.

The terms and words used in the following description and claims are not limited to their dictionary meanings, but are merely used to enable a clear and consistent understanding of the present invention. Accordingly, it should be apparent to those skilled in the art that the following description of embodiments of the present invention is provided for illustration purposes only and not for the purpose of limiting the present invention as defined by the appended claims and their equivalents.

The term “user” used herein may refer to a person or machine (e.g., an artificial intelligence apparatus or system) using an electronic device.

Herein, an electronic device may include a display function, such as a smart phone, a tablet PC, a mobile phone, a video phone, an e-book reader, a desktop PC, a laptop PC, a netbook computer, a PDA (Personal Digital Assistant), a PMP (Portable Multimedia Player), an MP3 player, a portable medical device, a digital camera, or a wearable device (e.g., an HMD (Head-Mounted Device) such as electronic glasses, electronic clothes, an electronic bracelet, an electronic necklace, an electronic appcessory, or a smart watch).

Herein, an electronic device may be a smart home appliance that involves a display function. For example, an electronic device may be a TV, a DVD (Digital Video Disk) player, audio equipment, a refrigerator, an air conditioner, a vacuum cleaner, an oven, a microwave, a washing machine, an air cleaner, a set-top box, a TV box (e.g., Samsung HomeSync™, Apple TV™, or Google TV™), a game console, an electronic dictionary, an electronic key, a camcorder, or an electronic picture frame.

Herein, an electronic device may be a medical device (e.g., MRA (Magnetic Resonance Angiography), MRI (Magnetic Resonance Imaging), CT (Computed Tomography), or ultrasonography), a navigation device, a GPS (Global Positioning System) receiver, an EDR (Event Data Recorder), an FDR (Flight Data Recorder), a car infotainment device, electronic equipment for ship (e.g., a marine navigation system, a gyrocompass, etc.), avionics, security equipment, an industrial or home robot, an ATM (Automatic Teller's Machine), or a POS (Point of Sale).

Additionally, an electronic device may be a piece of furniture or part of a building or construction having a display function, an electronic board, an electronic signature receiving device, a projector, or measuring instruments (e.g., a water meter, an electric meter, a gas meter, a wave meter, etc.). An electronic device disclosed herein may be one of the above-mentioned devices or any combination thereof. Also, an electronic device disclosed herein may be a flexible device. As will be understood by those skilled in the art, the foregoing examples of an electronic device are merely examples, and the present invention is not limited thereto.

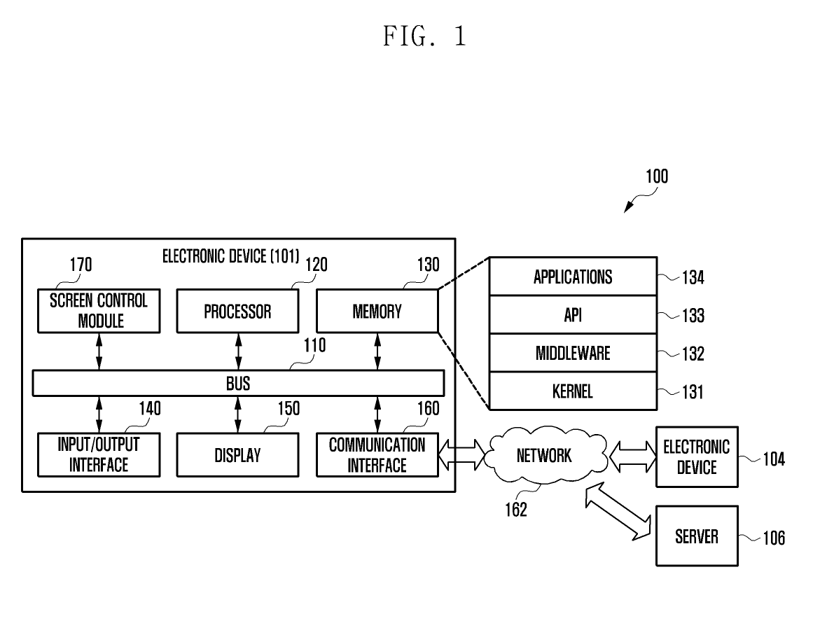

FIG. 1 illustrates the network architecture including the electronic device according to embodiments of the present invention.

Referring to FIG. 1, the electronic device 101 includes a bus 110, a processor 120, a memory 130, an input/output interface 140, a display 150, a communication interface 160, and a screen control module 170.

The bus 110 may be a circuitry which connects the aforementioned components to each other to communicate signals (e.g. control messages) therebetween.

The processor 120 receives a command from any of the aforementioned components (e.g. memory 130, input/output interface 140, display 150, communication interface 160, and screen control module 170) through the bus 110, interprets the command by decrypting the command, and executes operation or data processing according to the decrypted command.

The memory 130 stores the command or data received from or generated by the processor 120 or any of the aforementioned components. The memory 130 stores program modules, including but not limited to a kernel 131, middleware 132, Application Programming Interface (API) 133, and applications 134. Each programming module may be implemented as software, firmware, hardware, and any combination thereof.

The kernel 131 controls or manages the system resources (e.g. bus 110, processor 120, and memory 130) for use in executing the operation or function implemented with the middleware 132, the API 133, or the applications 134. The kernel 131 also provides an interface allowing the middleware 132, API 133, or applications 134 to access the components of the electronic device 101 to control or manage.

The middleware 132 operates as a relay of data communicated between the API 133 or applications 134 and the kernel 131. The middleware 132 may execute control of the task requests from the applications 134 in such a manner as to assign priority for use of the system resource (e.g. bus 110, processor 120, and memory 130) of the electronic device to at least one of the applications 134.

The API 133 is the interface for the applications 134 to control the function provided by the kernel 131 or the middleware 132 and includes at least one interface or function (e.g. command) for file, window, image or text control.

The applications 134 may include Short Messaging Service/Multimedia Messaging Service (SMS/MMS), email, calendar, alarm, health care (e.g. application of measuring quantity of motion or blood sugar level), and environmental information applications (e.g. atmospheric pressure, humidity, and temperature applications). The applications 134 may also be related to information exchange between the electronic device 101 and an external electronic device (e.g. electronic device 104), such as a notification relay application for relaying specific information to the external electronic device 104 and a device management application for managing the external electronic device.

For example, the notification relay application may be provided with a function of relaying the alarm information generated by the other applications (e.g. SMS/MMS application, email application, health care application, and environmental information application) of the electronic device to the external electronic device 104. The notification relay application may provide the user with the notification information received from the external electronic device 104. The electronic device application may manage (e.g. install, delete, and update) the function of an external electronic device (e.g. turn-on/off of the entire or a portion of the electronic device 104 or adjustment of the brightness (or resolution) of the display) which communicates with the electronic device 101 or the service (e.g. communication or messaging service) provided by the external electronic device or an application running on the external device.

The applications 134 may include an application designated according to the property (e.g. type) of the external electronic device 104. For example, when the external electronic device is the MP3 player, the applications 134 include a music playback application. Similarly, when the external electronic device is a mobile medical appliance, the applications 134 include a heal care application. The applications 134 may include at least one of applications designated to the electronic device 101 or received from the external electronic device (e.g. server 106 and electronic device 104).

The input/output interface 140 delivers the command or data input by the user through with an input/output device (e.g. sensor, keyboard, and touchscreen) to the processor 120, memory 130, communication interface 160, and/or screen control module 170 through the bus 110. For example, the input/output interface 140 provides the processor 120 with the data corresponding to the touch made by the user on the touchscreen. The input/output interface 140 outputs the command or data (which is received from the processor 120, memory 130, communication interfaced 160, or the operation module 170 through the bus 110) through the input/output device (e.g. a speaker and display 150). For example, the input/out interface 140 outputs the voice data processed by the processor 120 to the user through the speaker.

The display 150 presents information (e.g. multimedia data and text data) to the user.

The communication interface 160 establishes a communication connection of the electronic device 101 with an external device (e.g. electronic device 104 and server 106). For example, the communication interface 160 connects to the network 162 through a wireless or wired link for communication with the external device. Examples of the wireless communication technology include Wireless Fidelity (Wi-Fi), Bluetooth® (BT), Near Field Communication (NFC), Global Positioning System (GPS), and cellular communication technology (e.g. Long Term Evolution (LTE), LTE-Advanced (LTE-A), Code Division Multiple Access (CDMA), Wideband CDMA (WCDMA), Universal Mobile Telecommunication System (UMTS), Wireless-Broadband (WiBro), and Global System for Mobile communications (GSM)). Examples of the wired communication technology include Universal Serial Bus (USB), High Definition Multimedia Interface (HDMI), Recommended Standard 232 (RS-232), and Plain Old Telephone Service (POTS).

According to an embodiment, the network 162 may be a telecommunications network having at least one of a computer network, Internet, Internet of Things, and telephone network. The communication protocol between the electronic device 101 and an external device (e.g. transport layer protocol, data link layer protocol, and physical layer protocol) may be supported by at least one of the applications 134, API 133, middleware 132, kernel 131, and communication interface 160.

The screen control module 170 processes at least part of information obtained from the other elements (e.g., the processor 120, the memory 130, the input/output interface 140, or the communication interface 160) and offers the information to a user in various manners. For example, using the processor 120 or independently therefrom, the screen control module 170 controls at least some functions of the electronic device 101 such that the electronic device 101 interworks with another electronic device 104 or 106.

Hereinafter, an apparatus for displaying a screen in an electronic device according to embodiments of the present invention will be discussed. This screen display apparatus includes a display unit configured to display a size-adjusted screen changed from a full screen of the electronic device and display an auxiliary screen in an outside region of the size-adjusted screen (hereinafter, referred to as ‘outside region’), and a control unit configured to receive a request for displaying the size-adjusted screen, and thereby, control the display unit to display thereon the size-adjusted screen and the auxiliary screen.

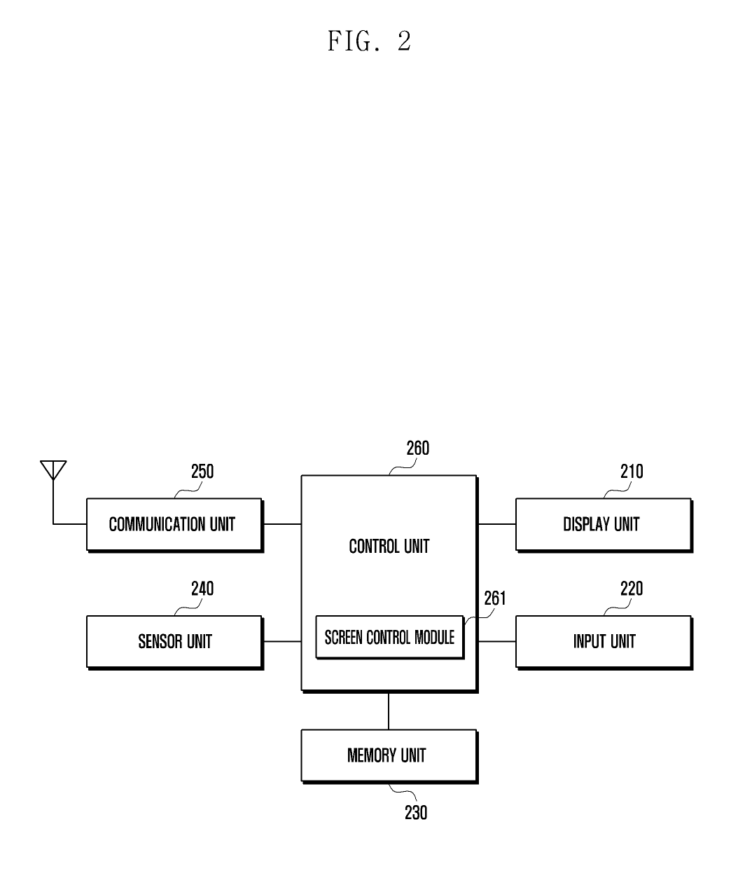

FIG. 2 is a block diagram illustrating a basic configuration of an electronic device in accordance with an embodiment of the present invention.

Referring to FIG. 2, the electronic device includes a display unit 210, an input unit 220, a memory unit 230, a sensor unit 240, a communication unit 250, and a control unit 260. The control unit 260 includes therein a screen control module 261. The display unit 210 may be formed of LCD (Liquid Crystal Display), OLED (Organic Light Emitting Diodes), AMOLED (Active Matrix Organic Light Emitting Diodes), for example, and visually offers various types of information to a user, such as a menu of the electronic device, input data, and function setting information.

The display unit 210 according to embodiments of the present invention displays a screen having size adjusted under the control of the control unit 260. For example, when a user inputs a command (e.g., a predetermined key input or gesture input) associated with an adjustment of a screen size, the display unit 210 displays a size-adjusted (e.g., a size-reduced) screen. When the size-adjusted screen is displayed, the display unit 210 displays a separate auxiliary screen for supporting the execution of additional functions outside of the perimeter of the size-adjusted screen.

The input unit 220 receives a key input and a touch input from a user and then transfers the received input to the control unit 260. The input unit 220 includes therein a touch panel or an external key, for example. The touch panel operates as a capacitive overlay, resistive overlay, or infrared beam, for example. Any other manner of sensing contact or pressure of an object may be also used for the touch panel.

The touch panel receives a user's touch input and recognizes the location of a touch point. According to an embodiment of the present invention, the touch panel receives a command accompanying a touch input among commands entered by a user to display a size-adjusted screen. For example, when a specific touch gesture is set as a command for the electronic device to display a size-adjusted screen, the touch panel receives a touch signal and transfers the signal to the control unit 260. Through this process, the electronic device determines whether a user performs a touch gesture input. The touch panel may also sense a user's input for adjusting a degree of reducing or enlarging a screen of the electronic device.

The touch panel may receive a touch input for performing interaction between a size-adjusted screen and the outside region in embodiments of the present invention. For example, in response to a user's specific touch gesture, specific content displayed on the size-adjusted screen changes a display position to the outside region, and vice versa. The touch panel also receives a variety of touch inputs and transmits these inputs to the control unit 260.

In embodiments of the present invention, the input unit 220 senses a key input through an external key and then transmits the sensed signal to the control unit 260. The external key may be preset so as to transmit an input signal for requesting an adjustment of screen size to the control unit 260. In this case, the input unit 220 senses the input of the predefined external key and transmits the signal for requesting an adjustment of screen size to the control unit 260.

The memory unit 230 is configured to store therein a program and data required for operation of the electronic device, such as a booting program, at least one operation system, and applications. The operating system acts as an interface between hardware and application and between applications, and also manages computer resources such as a CPU, GPU, and main memory. The memory unit 230 according to embodiments of the present invention stores in advance types of specific commands for displaying a size-adjusted screen. Such command types may be set as, for example, a specific touch gesture, and a specific key input. When a size-adjusted screen is displayed, the memory unit 230 stores types of programs by classifying these programs into a type for display on a size-adjusted screen and another type for display outside of the size-adjusted screen.

For example, when a specific SNS (Social Networking Service) application is executed on the size-adjusted screen, the outside of the size-adjusted screen may be set to display thereon a list of linked applications offered by the SNS application. Herein, applications and their execution screens displayed on the size-adjusted screen may be set differently from those displayed outside of the size-adjusted screen, and all setting information related to these settings may be stored in the memory unit 230.

The sensor unit 240 includes a variety of sensors such as a geomagnetic sensor, an acceleration sensor, and a gyro sensor, for sensing a motion input. The sensor unit 240 according to an embodiment of the present invention senses a motion input corresponding to a command for adjusting a screen size and then transmits a resultant signal to the control unit 260.

The communication unit 250 supports a communication function of the electronic device, and includes an RF (Radio Frequency) transmitter to up-convert the frequency of an outgoing signal and amplify the up-converted signal, an RF receiver to low-noise-amplify an incoming signal and down-convert the frequency of the amplified signal, for example. The communication unit 250 may further include a mobile communication module, a digital broadcasting module, and a short-range communication module. When of a wired connection is made with a specific device, the communication unit 250 supports a wired communication as well as the above-discussed wireless communication.

The communication unit 250 according to embodiments of the present invention receives, through wired or wireless communication information associated with notification and a graphic user interface to be displayed on or outside of the size-adjusted screen, and then transmits the received information to the control unit 260. Additionally, the communication unit 250 receives a specific event for displaying a size-adjusted screen of the electronic device. For example, when an execution screen of a specific application is displayed on the entire display unit 210, the communication unit 250 notifies the occurrence of a wireless communication signal such as a call or text message to the control unit 260. Then the screen displayed on the entire display unit 210 is adjusted (e.g., reduced) in size, so that information regarding such notification is displayed outside of the size-adjusted screen.

The control unit 260 performs a function to control the overall operation of the electronic device, and includes therein the screen control module 261. The control unit 260 determines whether any event pre-stored as a command for adjusting a screen occurs. As mentioned above, such command types include a key, gesture, and motion input, for example. When the occurrence of a communication event (e.g., an incoming call, a message, or a push notification) is sensed through the communication unit 250, the control unit 260 controls the display of a size-adjusted screen and information regarding the received specific signal outside of the size-adjusted screen.

When changing a screen in response to a predefined event (e.g., a change in a display screen caused by a predetermined alarm during a game), the control unit 260 adjusts (e.g., reduce) the displayed entire screen and displays a new window on the outside region. Specifically, the control unit 260 controls the display unit 210 to display a size-adjusted screen when recognizing the occurrence of a user event such as a touch gesture input, a key input, or a motion input or the occurrence of the aforesaid communication event or predefined screen change event.

The control unit 260 controls specific content, being displayed on the size-adjusted screen, to be displayed outside of the size-adjusted screen in response to a user's request (e.g., a drag). The control unit 260 sets and controls a specific application to be preferentially displayed on the outside region. When the size-adjusted screen is displayed, the control unit 260 changes the configuration of menu to be displayed on the outside region according to states of the screen displayed on the size-adjusted screen (e.g., a main screen display state, or an application execution state) or according to types of application executed on the size-adjusted screen.

Since the “outside region of the size-adjusted screen” is referred to as “outside region”, as previously set forth, the “outside region” is to be understood as indicating all regions of the display unit where the size-adjusted screen is not displayed.

As discussed hereinbefore, the screen display apparatus of the electronic device according to embodiments of the present invention includes a display unit configured to display a size-adjusted screen changed from a full screen of the electronic device and display an auxiliary screen in an outside region, and a control unit configured to receive a request for displaying the size-adjusted screen and thereby control the display unit to display thereon the size-adjusted screen and the auxiliary screen.

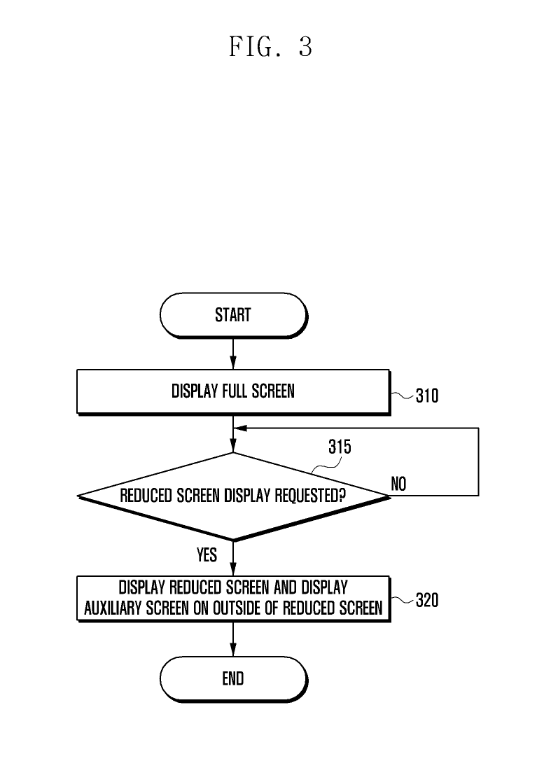

FIG. 3 illustrates a screen display method in accordance with embodiments of the present invention.

At step 310, the control unit 260 controls to display a screen on the entire display unit 210. At step 315, the control unit 260 determines whether there is a request for displaying a size-adjusted screen, such as by a predetermined touch gesture, key input, or motion. If there is no request for displaying the size-adjusted screen, the control unit 260 re-performs the determination of whether there is a request for displaying the size-adjusted screen. When any request for displaying the size-adjusted screen is recognized at step 315, the control unit 260 at step 320 controls displaying the size-adjusted screen and an auxiliary screen on an outside region. Thereafter, the control unit 260 ends the process of FIG. 3. In addition, the electronic device may display the size-adjusted screen and the outside region thereof according to embodiments of the present invention.

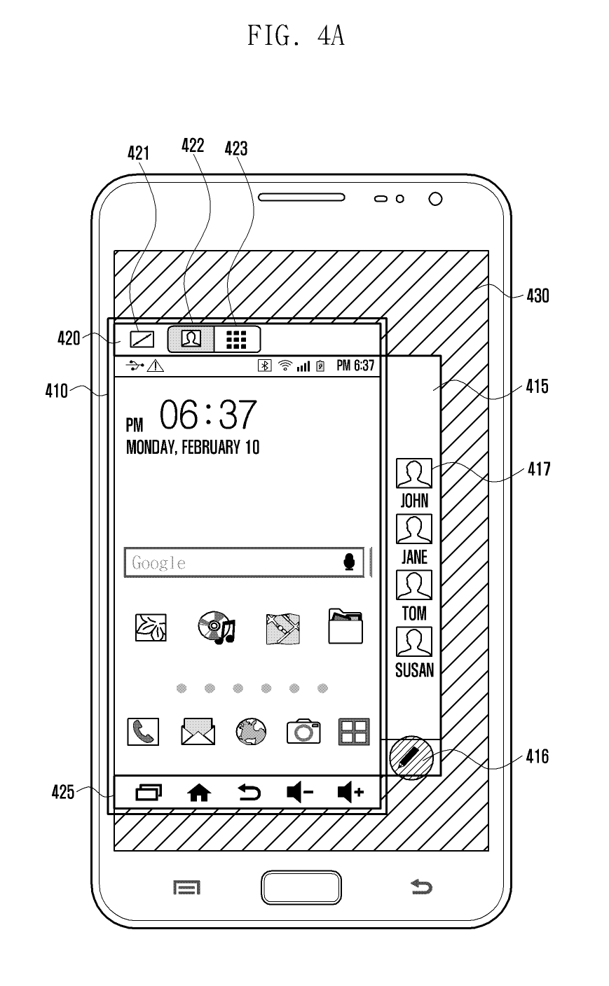

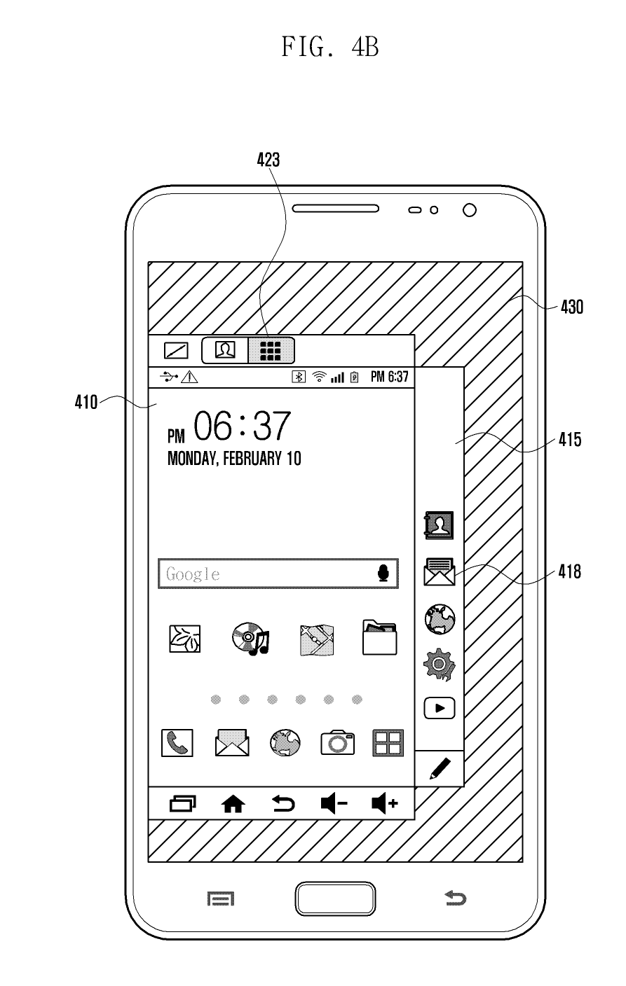

FIGS. 4A-4B, 5A-5C, 6A-6C, and 7A-7F are screenshots illustrating operations of adjusting a screen in accordance with embodiments of the present invention.

FIGS. 4A and 4B illustrate examples of displaying an outer display bar outside region and also displaying icons of contacts or applications set by a user on the outer display bar.

FIG. 4A illustrates a full screen adjusted in size and then displayed on the left of the display unit 210. As illustrated in FIG. 4A, a size-adjusted screen 410 is displayed together with an upper display bar 420 and a lower display bar 425. The upper display bar 420 includes a button 421 for returning the size-adjusted screen to the full screen and other buttons 422 and 423 for selecting a menu to be displayed on an outside region 430. FIG. 4A illustrates the button 422 indicating a contact list selected from among buttons displayed on the upper display bar 420 of the size-adjusted screen 410. Thus, an outer display bar 415 is displayed on the outside region 430. The outer display bar 415 is displayed at any position on the outside region 430 and in the form of a longitudinal bar as illustrated or other forms such as a circular or an oval form.

When the button 422 indicating a contact list is selected from the upper display bar 420, information regarding a contact list is displayed on the outer display bar 415. This contact list information may be modified by selecting the edit button 416. Additionally, external keys (e.g., a volume, cancel, home, and menu key) of the electronic device are displayed on the lower display bar 425. Since such external keys are displayed on the lower display bar 425, a user can easily select the external keys in his or her one hand. Besides, the upper display bar 420 or the lower display bar 425 may offer, at a part thereof, a function to change the location and size 410. The locations of the upper display bar 420 and the lower display bar 425 may vary, and the configuration of buttons displayed on the upper display bar 420 and the lower display bar 425 may be modified.

Meanwhile, FIG. 4B illustrates the button 423 indicating an icon arrangement being selected from the upper display bar 423 of the size-adjusted screen 410. In response to this selection, icons 418 of applications are displayed on the outer display bar 415. The configuration of these icons 418 displayed on the outer display bar 415 may be modified depending on a user's selection.

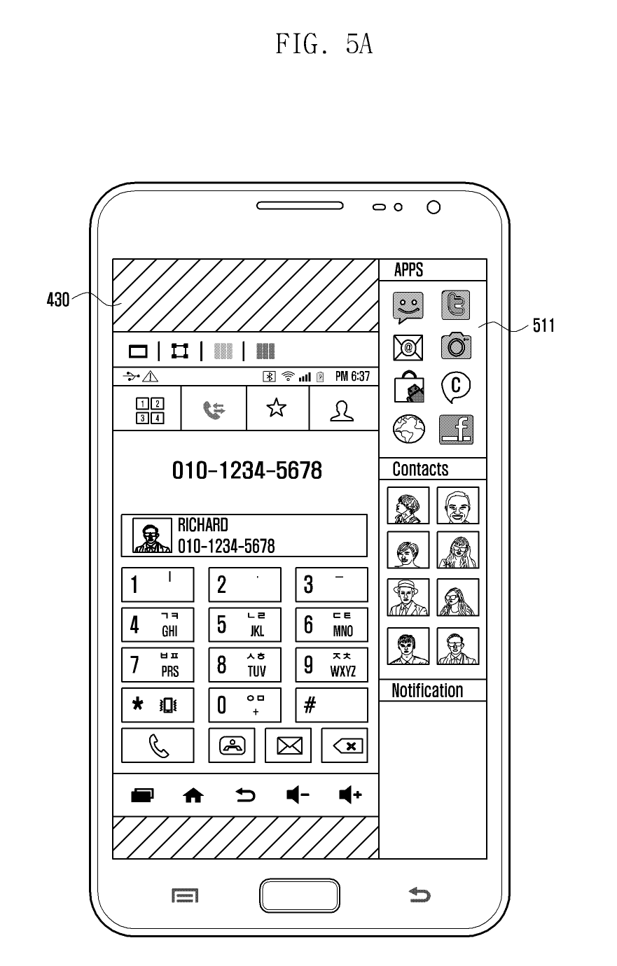

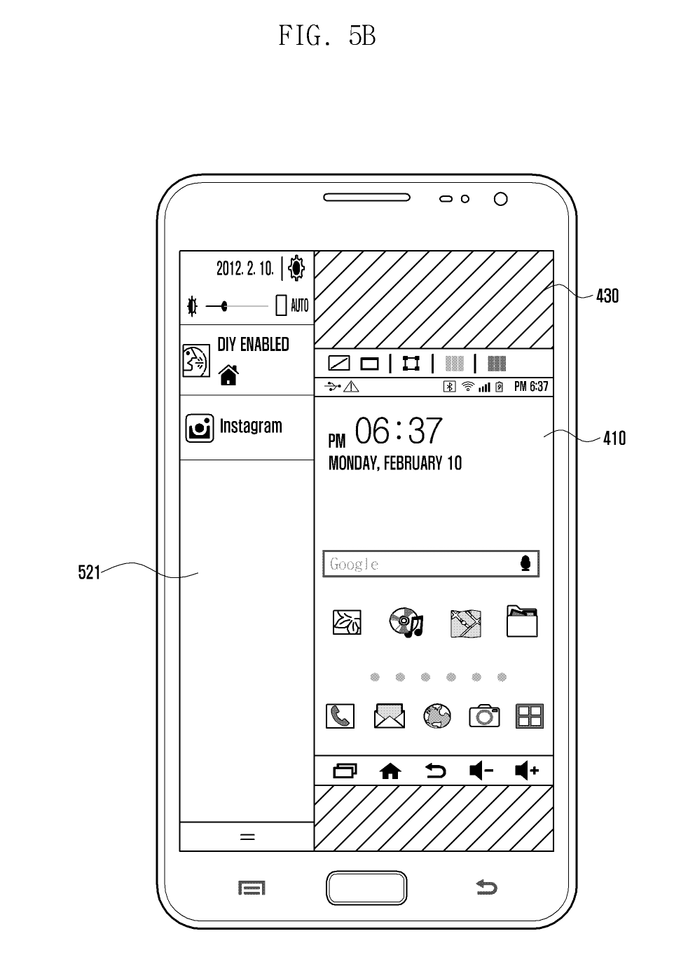

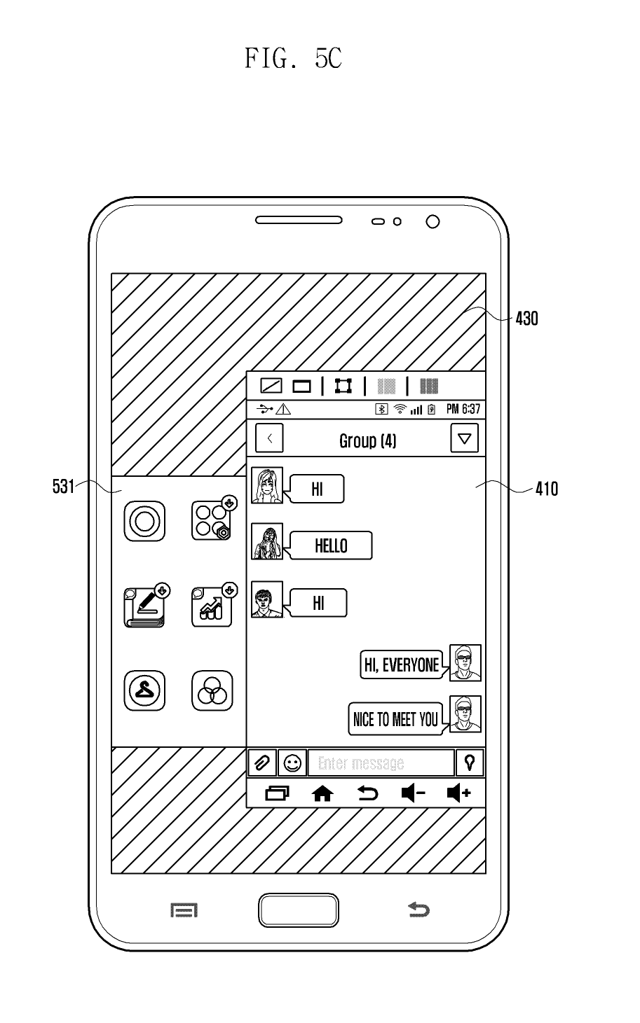

FIGS. 5A to 5C illustrate examples of displaying menu areas on the outside region 430 of the size-adjusted screen.

FIG. 5A illustrates a plurality of menu items simultaneously displayed on the outside region 430 of the size-displayed screen 410. As illustrated in FIG. 5A, a menu area 511 includes, for example, an application list, a contact list, and a notification. The application list may include frequently used applications, preset by a user, and applications being executed on the screen background. For example, the menu area 511 may be configured in a bar-like longitudinal form as illustrated, or in a square or oval form. If necessary, the menu area 511 may be hidden.

Since the location of the outside region 430 is varied according to that of the size-adjusted screen 410, the menu area 511 may move depending on the location of the size-adjusted screen 410. For example, when the size-adjusted screen 410 is located at the right-hand side of the screen, the menu area 511 may be located at the left-hand side of the screen. Additionally, each item (e.g., an application list, a contact list, a notification) contained in the menu area 511 may be displayed respectively and separately.

FIG. 5B illustrates a notification menu displayed in a menu area 521 displayed on the outside region 430. In this manner, a specific item only is displayed on the outside region 430. For example, as illustrated in FIG. 5B, the notification menu only may appear in the menu area 521. The notification menu displays, for example, a list of received messages and a list of missed calls.

FIG. 5C illustrates a list of applications, linkable to or associated with applications displayed on the size-adjusted screen 410, being displayed on the outside region 430. For example, if an application supporting an SNS function is executed on the size-adjusted screen 410, associated applications such as a game, a shopping, and a media player which are executable in the above application are displayed in a menu area 531 displayed on the outside region 430. In another example, if a camera application is executed on the size-adjusted screen 410, an image view application or an image edit application associated with the camera application is displayed in the menu area 531. Similarly, if a browser is executed on the size-adjusted screen 410, a list such as a bookmark list associated with the browser is displayed in the menu area 531. When the application list or the bookmark list is selected, an execution page thereof is displayed on one of the size-adjusted screen 410 and the outside region 430.

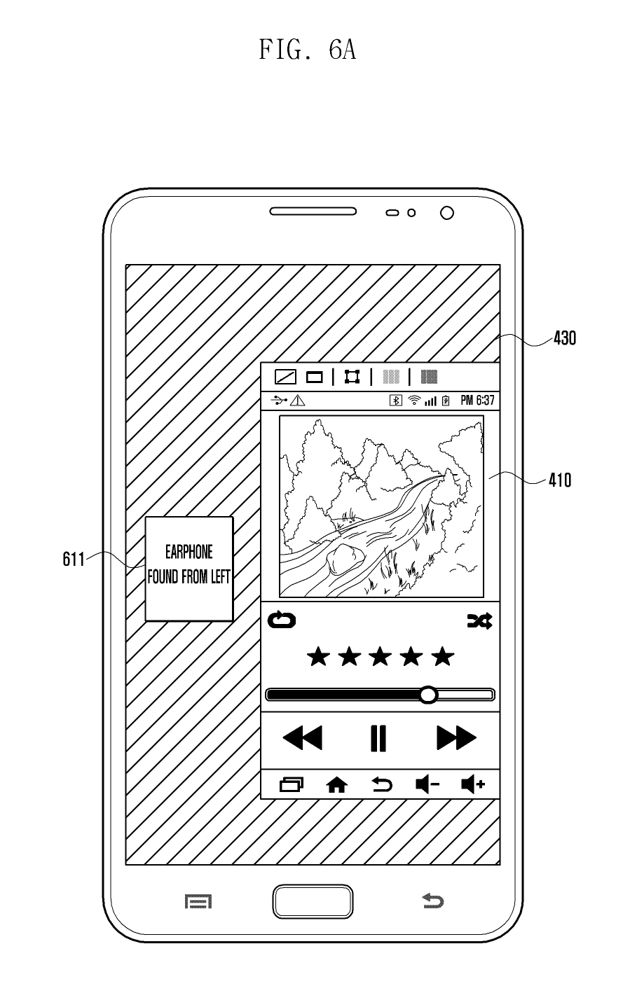

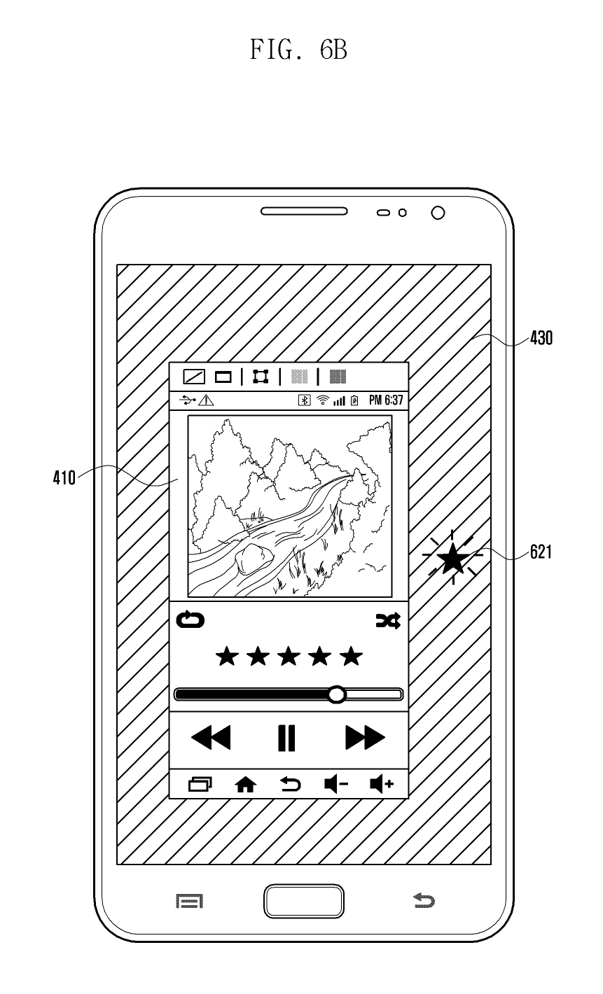

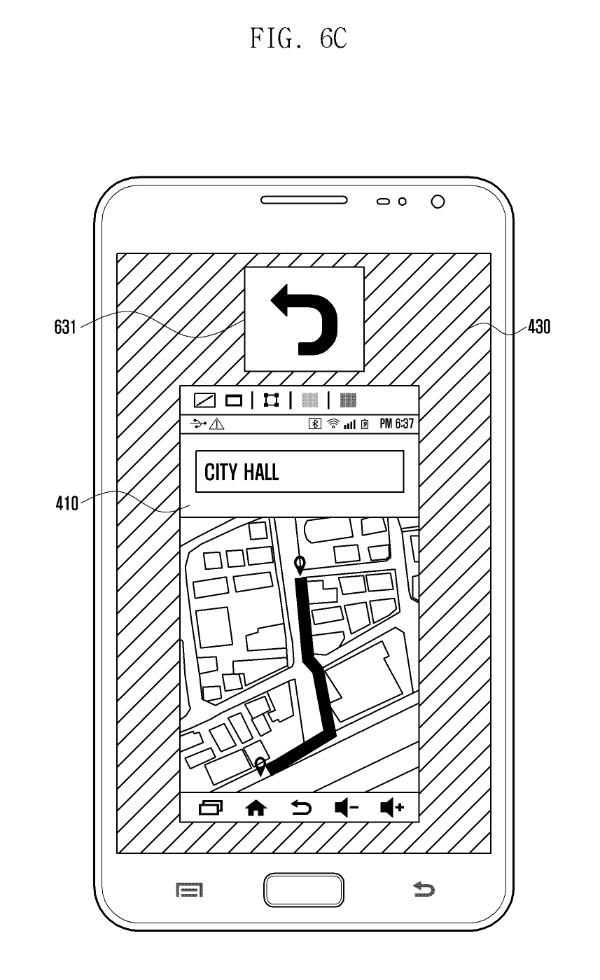

FIGS. 6A to 6C illustrate a function to represent a direction-related interface on the outside region. The direction-related interface may correspond to, for example, a message or a graphic object. Through the direction-related interface, the control unit 260 displays direction information associated with an application being executed on the size-adjusted screen, and displays additional information based on the direction information, as described with reference to FIG. 6A.

Specifically, FIG. 6A illustrates the size-adjusted screen 410 displayed on part of the screen, and a notification message 611 displayed on the outside region 430 410. In this manner, the notification message 611 for notifying a simple message to a user is displayed on the outside region 430. For example, when a certain audio file is executed on the size-adjusted screen 410, the control unit 260 determines whether a peripheral device such as an earphone from which a Bluetooth® signal is detected exists within a given distance, and determines the location of the existing peripheral device. The control unit 260 may find the existence and location of any other electronic device or AP (Access Point using short-range communication techniques. The location of other electronic device or peripheral device found in this manner may be immediately notified to a user on the outside region 430 through the notification message 611. Information that can be offered using the notification message 611 includes other additional information based on the direction information.

For example, when the existence of any wireless connectable peripheral device is ascertained, the control unit 260 displays a message such as ‘Do you attempt a wireless connection with a peripheral device found at the left-hand side of the screen?’ on the outside region 430. When the message is selected, the control unit 260 supports a function to automatically establish a wireless connection. In this manner, the control unit 260 may directly offer a user the direction information through the direction-related interface displayed on the outside region 430, and also may offer additional information (e.g., wireless connection enabled or disabled) which is available based on the direction information. The direction-related interface supports a simple execution of a function (e.g., a wireless connection with a specific device selected from the direction-related interface) corresponding to information offered.

FIG. 6B illustrates the size-adjusted screen 410 displayed at the center of the display unit 210 and a notification-related graphic object 621 displayed on the outside region 430. When the existence of a peripheral device is detected using a short-range communication such as Bluetooth® as illustrated like the notification message 611 in FIG. 6A, the notification-related graphic object 621 is displayed to notify this to a user. For example, when the existence of a peripheral device is detected from the right of the electronic device, the control unit 260 displays the notification-related graphic object 621 on the right of the display unit 210. In this manner, the notification-related graphic object 621 is displayed at a location (e.g., left, right, top, bottom) corresponding to a notification direction.

When the graphic object 621 is displayed at a location on the display unit 210 according to the notification direction, the size-adjusted screen 410 is displayed in the opposite direction of the direction information display location. For example, when the graphic object 621 is displayed at the left-hand side of the screen of the display unit 210 to notify the existence of an earphone disposed at the left-hand side of the screen, the size-adjusted screen 410 is displayed at the right-hand side of the screen of the display unit 210. In this manner, the location 410 may vary according to the location where the direction information is displayed.

The above-discussed situation of displaying the notification message 611 and the notification-related graphic object 621 in FIGS. 6A and 6B may be applied to notification situations as well as case of searching for a peripheral device. Also, the graphic object 621 may indicate not only direction information itself but also other additional information based on the direction information.

FIG. 6C illustrates another example of the notification-related graphic object. A notification-related graphic object 631 may offer direction information to a user at a fixed position on the outside region 430. For example, when a navigation function is executed on the size-adjusted screen 410, the control unit 260 may offer location information regarding destination as the notification-related graphic object 631. If the destination exists at the left-hand side of the screen from a current location, the notification-related graphic object 631 may show an image representing the left to a user.

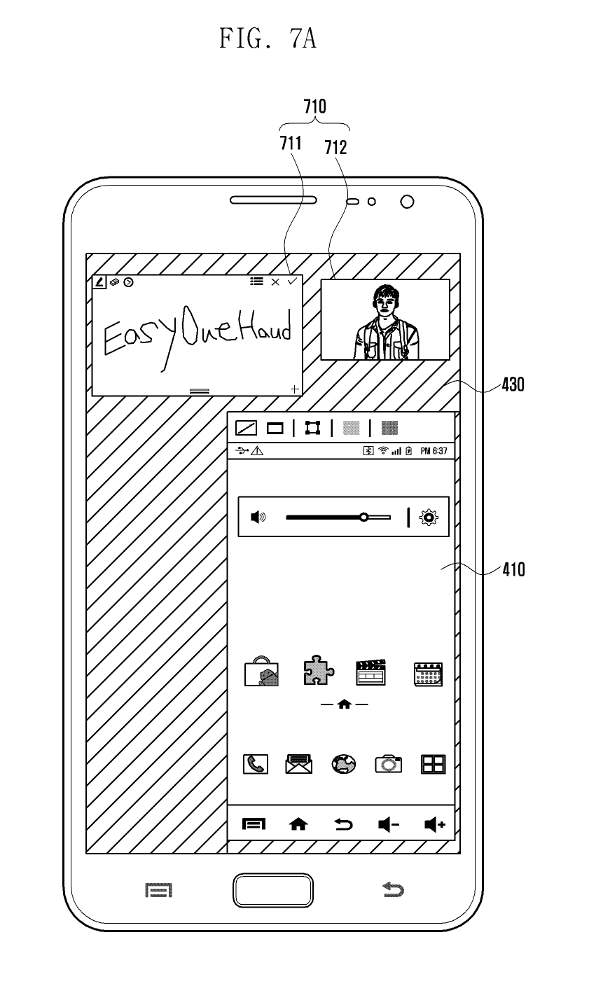

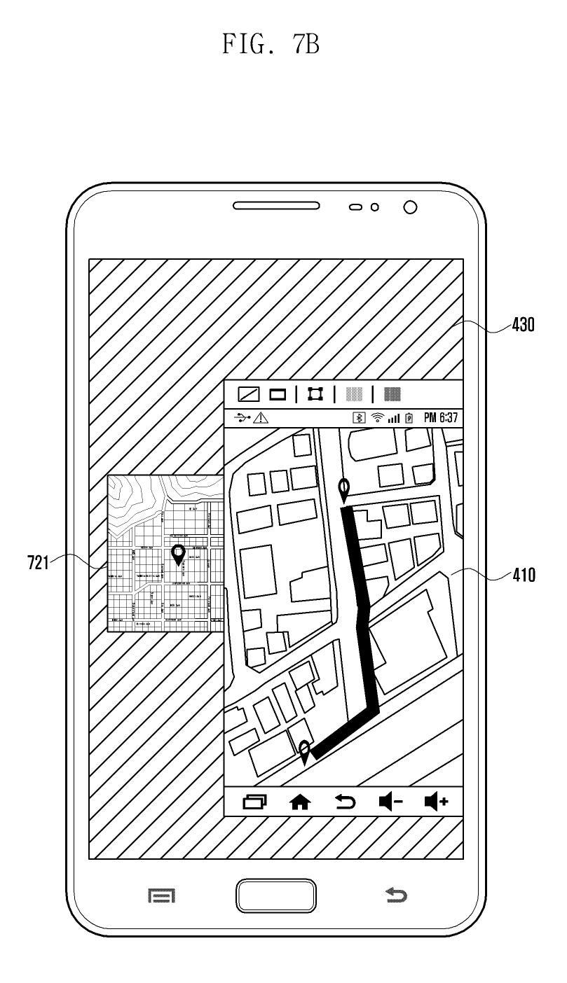

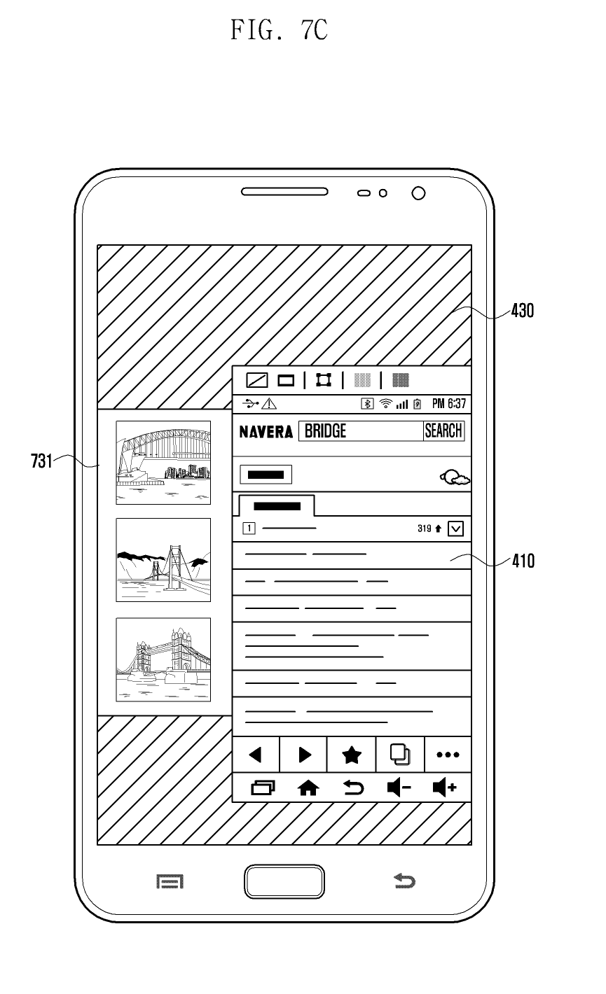

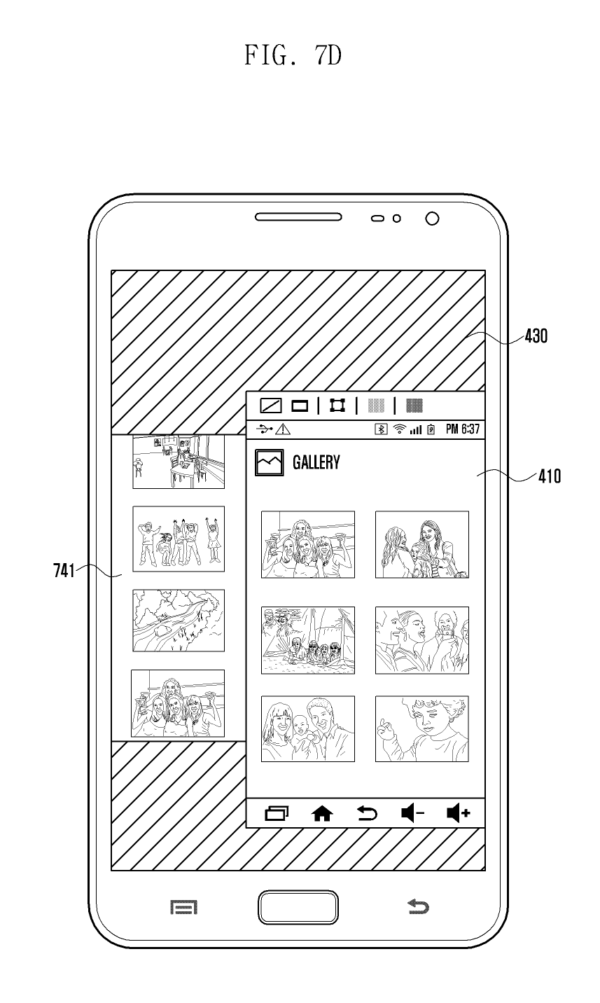

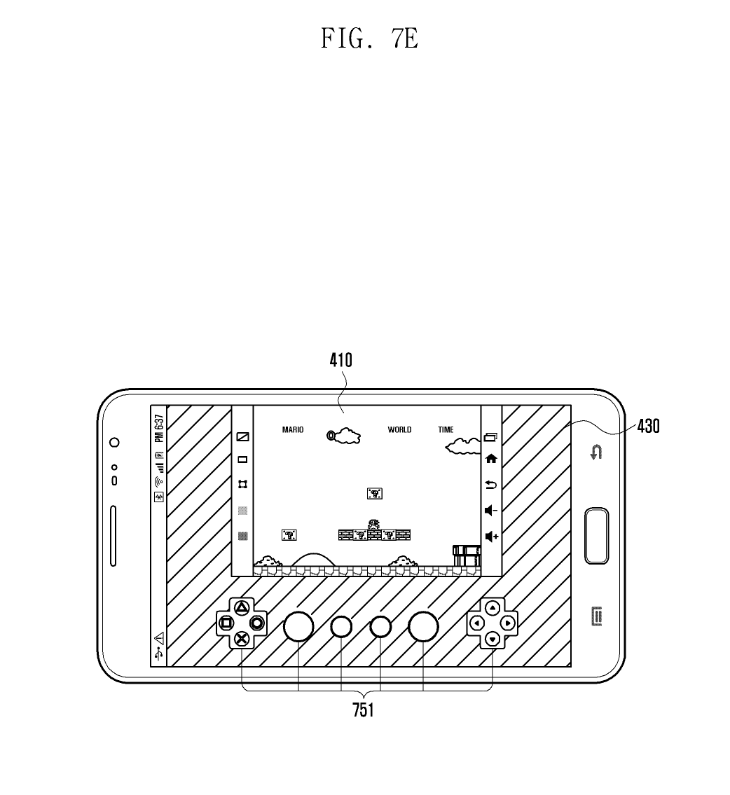

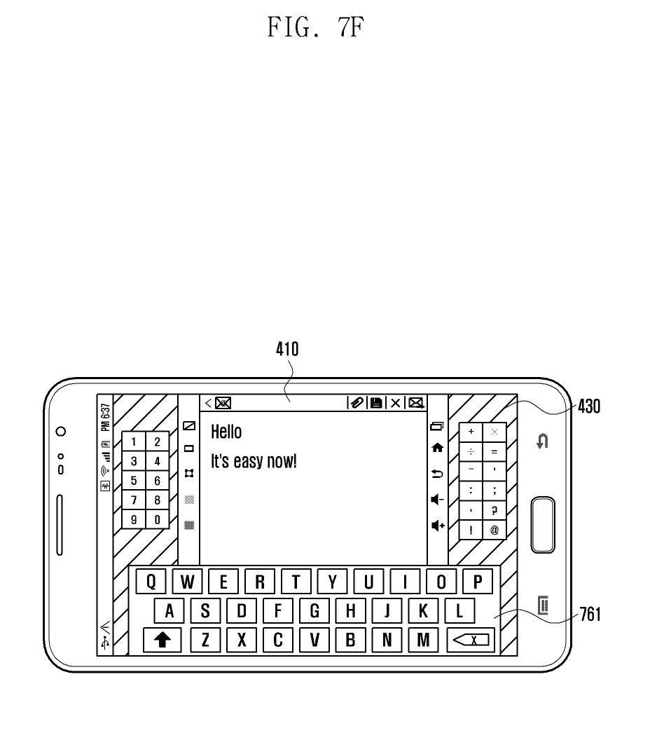

FIGS. 7A to 7F illustrate a separate application execution screen that is displayed on the outside region.

FIG. 7A illustrates a content execution window 710 displayed on the outside region 430 410. The content execution window 710 may depict an execution screen of a certain application. For example, the content execution window 710 includes a memo application execution screen 711 and a video execution screen 712. In this case, the content execution window 710 may be a screen in which an application selected from the size-adjusted screen 410 is executed. Also, the content execution window 710 is displayed on the outside region 430 only when an application to be displayed on the outside region 430 is selected. Although the content execution window 710 is located on the outside region 430 as illustrated, it may be located on the size-adjusted screen 410 in response to a user's manipulation, such as a drag.

Even when is already displayed on the size-adjusted screen 410, the content execution window 710 may be moved to the outside region 430 in response to a user's manipulation. For this, at manufacture, a specific application may be set to be able to move the content execution window 710 from the size-adjusted screen 410 to the outside region 430. When the content execution window 710 is drawn (e.g., dragged) to a page being executed in the size-adjusted screen 410 according to embodiments, the control unit 260 may execute a querying of whether to attach or share corresponding content.

For example, when a program allowing a file attachment such as instant message, email, or an SNS page is executed in the size-adjusted screen 410, an action of drawing the content execution window 710 outside region 430 to the size-adjusted screen 410 may be taken. The control unit 260 determines this as a file attachment action and performs a file attachment or displays a message of querying whether to attach a file.

FIG. 7B illustrates the size-adjusted screen 410 and the outside region 430 thereof display respectively mapping images having different scales for a navigation function. In this manner, when a user triggers a navigation function to find directions, the control unit 260 displays a map image, relatively enlarged to show a course, on the size-adjusted screen 410. When a user wishes to see the entire image of a current zone through a small-scale map, the control unit 260 displays a map image having a small scale in an auxiliary window 721 on the outside region 430. Through this, a user can see a zoom-in map on one screen and a zoom-out map on the other screen without repeating zoom in/out. The map images displayed respectively on the size-adjusted screen 410 and the outside region 430 may be execution screens of the same application. Alternatively, when a map-related application is displayed on the size-adjusted screen 410, the auxiliary window 721 displays a predetermined map application.

FIG. 7C illustrates a search function performed through a webpage on the size-adjusted screen 410 which displays a document found through the search function or any type of related page. Additionally, the outside region 430 may separately display on an auxiliary window 731 a search list of files having a specific format such as image or video associated with the search. Similarly, when a specific webpage is executed on the size-adjusted screen 410, a popup window or the like, launched at access to the webpage, may be separately displayed on the auxiliary window 731 of the outside region 430. When download or upload of any content is performed through the Internet, a related screen or page may be separately displayed on the auxiliary window 731 of the outside region 430.

FIG. 7D illustrates how an auxiliary window 741 of the outside region 430 may be used to check various contents on a single screen. Since such contents (e.g., images) are limited in number, a user who desires to check a previous page in the conventional art has to inconveniently return to the previous page, which is displayed again on the screen. However, according to embodiments of the present invention, it is possible to easily check a content list on a content list page (e.g., gallery, or an attached file selection page) displayed on the size-adjusted screen 410. For example, when a user checks content lists by flipping over pages thereof on the size-adjusted screen 410, the next list is displayed on the screen from which a previous list disappears. At this time, a content list that disappears from the size-adjusted screen 410 is displayed on the auxiliary window 741, as a reminder of the previous page to the user.

When the user is selecting content to be deleted in a gallery application and if the selected content disappears from the size-adjusted screen 410 due to a page change, the user may re-check the selected content through the auxiliary window 741 and easily select an item to be deleted from among contents currently displayed on the size-adjusted screen 410. This mitigates the inconvenience of having to return to the previous page. In addition, types of lists that are difficult to display on a single screen are separately displayed on the size-adjusted screen 410 and the auxiliary window 741.

FIGS. 7E and 7F illustrate a peripheral device that is displayed around the outside region 420 of the size-adjusted screen 710.

FIG. 7E illustrates the size-adjusted screen 410 displayed in a landscape mode and a game executed on the size-adjusted screen 410. In this manner, the size-adjusted screen 410 is displayed in the landscape mode as well as a portrait mode in response to a user's request. In the landscape mode, upper and lower display bars displayed with the size-adjusted screen 410 are moved to the left-hand side and the right-hand side of the screen, relative to the screen disposition as illustrated.

Additionally, FIG. 7E illustrates a game pad 751, which is a type of peripheral device, displayed on the outside region 430. Depending on embodiments of the present invention, types of the game pad 751 may vary. If a user causes the game pad 751 to be displayed on part of the outside region 430, the control unit 260 recognizes this as a connection of a peripheral device. When the game pad 751 is displayed on the display unit 210, manipulating buttons capable of being displayed on the size-adjusted screen 410 may be removed accordingly and a game may be played using the game pad 751.

Similarly, FIG. 7F illustrates a function to display an external device on the display unit 210, a word processor program executed on the size-adjusted screen 410, and a keyboard 761 displayed on the outside region 430. When the keyboard 761 is displayed on the outside region 430, the control unit 260 operates as if a mechanical keyboard is connected to the electronic device. For example, the control unit 260 receives a key input using the keyboard 761 recognized as a peripheral device without displaying a keypad on the size-adjusted screen 430 even though a word processor program is being executed on the size-adjusted screen 410.

As discussed above, the screen display method of the electronic device according to embodiments of the present invention includes recognizing a request for displaying the size-adjusted screen, displaying the size-adjusted screen on one region of the display unit in response to the request, and displaying the auxiliary screen on the outside region.

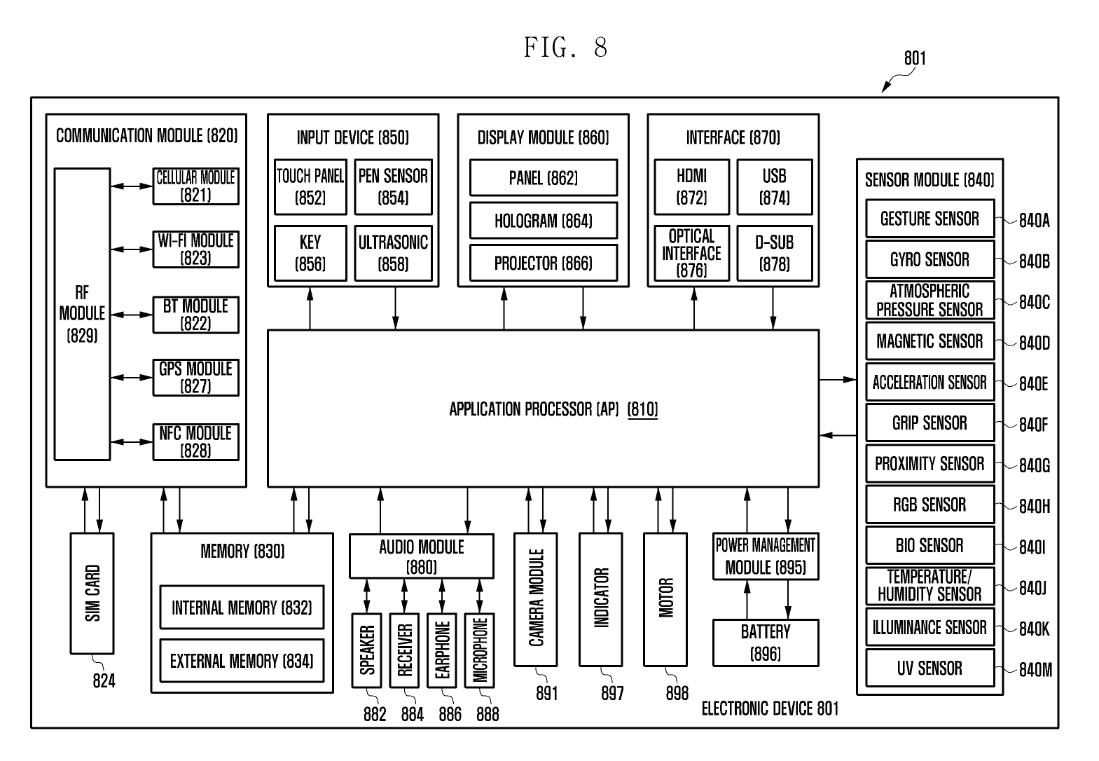

FIG. 8 is a block diagram illustrating a configuration of the electronic device according to embodiments of the present invention. The electronic device 801 may be all or a part of the electronic device 101. Referring to FIG. 8, the electronic device 801 includes an Application Processor (AP) 810, a communication module 820, a Subscriber Identity Module (SIM) card 824, a memory 830, a sensor module 840, an input device 850, a display module 860, an interface 870, an audio module 880, a camera module 891, a power management module 895, a battery 896, an indicator 897, and a motor 898.

The AP 810 operates an Operating System (OS) and/or application programs to control a plurality of hardware and/or software components connected to the AP 810 and perform data-processing and operations on multimedia data. For example, the AP 810 may be implemented in the form of System on Chip (SoC). According to an embodiment, the AP 810 includes a Graphic Processing Unit (GPU).

The communication module 820 (e.g. communication interface 160) performs data communication with other electronic devices (e.g. electronic device 104 and server 106) through a network. According to an embodiment, the communication module 820 includes a cellular module 821, a Wi-Fi module 823, a BT module 825, a GPS module 827, an NFC module 828, and a Radio Frequency (RF) module 829.

The cellular module 821 is responsible for voice and video communication, text messaging, and Internet access services through a communication network (e.g. LTE, LTE-A, CDMA, WCDMA, UMTS, WiBro, and GSM networks). The cellular module 821 performs identification and authentication of electronic devices in the communication network using the SIM card 824. According to an embodiment, the cellular module 821 performs at least one of the functions of the AP 810. For example, the cellular module 821 performs at least a part of the multimedia control function.

According to an embodiment, the cellular module 821 includes a Communication Processor (CP). The cellular module 821 may be implemented in the form of SOC. Although the cellular module 821 (e.g. communication processor), the memory 830, and the power management module 895 are depicted as independent components separated from the AP 810, the present invention is not limited thereto but may be embodied in a way that the AP includes at least one of the components (e.g. cellular module 821).

According to an embodiment, each of the AP 810 and the cellular module 821 (e.g. communication processor) may load a command or data received from at least one of the components on a non-volatile or volatile memory and process the command or data. The AP 810 or the cellular module 821 stores the data received from other components or generated by at least one of other components in the non-volatile memory.

Each of the Wi-Fi module 823, the BT module 825, the GPS module 827, and the NFC module 828 includes a processor for processing the data it transmits/receives. Although the cellular module 821, the Wi-Fi module 923, the BT module 825, the GPS module 827, and the NFC module 828 are depicted as independent blocks; at least two of them (e.g. communication processor corresponding to the cellular module 821 and Wi-Fi processor corresponding to the Wi-Fi module 823) may be integrated in the form of SoC.

The RF module 829 is responsible for data communication, e.g. transmitting/receiving RF signals. Although not depicted, the RF module 829 includes a transceiver, a Power Amp Module (PAM), a frequency filter, and a Low Noise Amplifier (LNA). The RF module 829 also includes the elements for transmitting/receiving electric wave in free space, e.g. conductor or conductive wire. Although FIG. 8 is directed to the case where the Wi-Fi module 823, the BT module 825, the GPS module 827, and the NFC module 828 are sharing the RF module 829, the present invention is not limited thereto but may be embodied in a way that at least one of the Wi-Fi module 823, the BT module 825, the GPS module 827, and the NFC module 828 transmits/receives RF signals an independent RF module.

The SIM card 824 may be designed so as to be inserted into a slot formed at a predetermined position of the electronic device. The SIM card 824 stores unique identity information (e.g. Integrated Circuit Card Identifier (ICCID)) or subscriber information (e.g. International Mobile Subscriber Identity (IMSI)).

The memory 830 (e.g. memory 130) includes at least one of the internal memory 832 and an external memory 834. The internal memory 832 includes at least one of a volatile memory (e.g. Dynamic Random Access Memory (DRAM), Static RAM (SRAM), Synchronous Dynamic RAM (SDRAM) or a non-volatile memory (e.g. One Time Programmable Read Only Memory (OTPROM), Programmable ROM (PROM), Erasable and Programmable ROM (EPROM), Electrically Erasable and Programmable ROM (EEPROM), mask ROM, flash ROM, NAND flash memory, and NOR flash memory).

According to an embodiment, the internal memory 832 may be a Solid State Drive (SSD). The external memory 834 may be a flash drive such as Compact Flash (CF), Secure Digital (SD), micro-SD, Mini-SD, extreme Digital (xD), and Memory Stick. The external memory 834 may be connected to the electronic device 801 through interfaces functionally. According to an embodiment, the electronic device 801 includes a storage device (or storage medium) such as hard drive.

The sensor module 840 may measure physical quantity or check the operation status of the electronic device 801 and convert the measured or checked information to an electric signal. The sensor module 840 includes at least one of gesture sensor 840A, Gyro sensor 840B, atmospheric pressure sensor 840C, magnetic sensor 840D, acceleration sensor 840E, grip sensor 840F, proximity sensor 840G, color sensor 840H (e.g. Red, Green, Blue (RGB) sensor), bio sensor 8401, temperature/humidity sensor 840J, illuminance sensor 840K, and Ultra Violet (UV) sensor 840M. The sensor module 840 may include an E-nose sensor, Electromyography (EMG) sensor, Electroencephalogram (EEG) sensor, Electrocardiogram (ECG) sensor, Infrared (IR) sensor, iris sensor, and fingerprint sensor. The sensor module 840 may further include a control circuit for controlling at least one of the sensors included therein.

The input device 850 includes a touch panel 852, a (digital) pen sensor 854, keys 856, and an ultrasonic input device 858. The touch panel 852 may be one of a capacitive, resistive, infrared, and microwave type touch panel, and includes a control circuit. In the case of the capacitive type touch panel, it is possible to detect physical contact or approximation. The touch panel 852 may further include a tactile layer. In this case, the touch panel 852 provides the user with a haptic reaction.

The (digital) pen sensor 854 may be implemented with a sheet in the same or similar manner as touch input of the user or a separate recognition sheet. The keys 856 includes physical buttons, an optical key, and keypad. The ultrasonic input device 858 is capable of checking data by detecting sound waves through a microphone 888 and is implemented for wireless recognition. According to an embodiment, the electronic device 801 receives the user input made by means of an external device (e.g. computer or server) connected through the communication module 820.

The display module 860 (e.g. display module 150) includes a panel 862, a hologram device 864, and a projector 866, is a Liquid Crystal Display (LCD) panel or an Active Matrix Organic Light Emitting Diodes (AMOLED) panel, is implemented so as to be flexible, transparent, and/or wearable and is implemented as a module integrated with the touch panel 852. The hologram device 864 presents 3-dimentional image in the air using light interference. The projector 866 projects an image to a screen that is placed inside or outside the electronic device. According to an embodiment, the display module 860 includes a control circuit for controlling the panel 862, the hologram device 864, and the projector 866.

The interface 870 includes a High-Definition Multimedia Interface (HDMI) 872, a Universal Serial Bus (USB) 874, an optical interface 876, and a D0subminiature (D-sub) 878. The interface 870 includes the communication interface 160 as illustrated in FIG. 1, and may include a Mobile High-definition Link (MHL) interface, a SD/MMC card interface, and infrared Data Association (irDA) standard interface (not shown).

The audio module 880 converts sound to an electric signal and vice versa. At least a part of the audio module 880 may be included in the input/output interface 140 as illustrated in FIG. 1. The audio module 880 processes the audio information input or output through the speaker 882, the receiver 884, the earphone 886, and the microphone 888.

The camera module 891 is capable of taking still and motion pictures and, according to an embodiment, includes at least one image sensor (e.g. front and rear sensors), a lens, and Image Signal Processor (ISP), and a flash (e.g. LED or xenon lamp).

The power management module 895 manages the power of the electronic device 801. Although not illustrated, the power management module 895 includes a Power Management Integrated Circuit (PMIC), a charger Integrated Circuit (IC), a battery, and a battery gauge.

The PMIC may be integrated into an Integrated Circuit (IC) or SoC semiconductor. The charging is classified into wireless and wired charging. The charger IC charges the battery and protects the charger against overvoltage or overcurrent. According to an embodiment, the charger IC includes at least one of wired and wireless charger ICs. Examples of the wireless charging technology include resonance and electromagnetic wave wireless charging, and an additional circuit is needed for wireless charging such as coil loop, resonance circuit, and diode.

The battery gauge measures the residual power of the battery 896, charging voltage, current, and temperature. The battery 896 stores or generates power and supplies the stored or generated power to the electronic device 801. The battery 896 includes a rechargeable battery or a solar battery.

The indicator 897 displays the operation status of the electronic device 801 or a part of the electronic device, booting status, messaging status, and charging status. The motor 898 converts the electronic signal to a mechanical vibration. Although not illustrated, the electronic device 801 includes a processing unit (e.g. GPU) for supporting mobile TV. The processing unit processes the media data in conformance with the broadcast standards such as Digital Multimedia Broadcasting (DMB), Digital Video Broadcasting (DVB), and media flow.

As described above, the text display method and apparatus of an electronic device of the present invention is advantageous in terms of reducing a number of page scrolls by discerning the paragraphs included in a text document and folding the paragraphs to present parts of the respective paragraphs.

Also, the text display method and apparatus of an electronic device of the present invention also improves the legibility of the text by enlarging, when a folded paragraph is stretched, the font size of the paragraph or highlighting the paragraph.

The above enumerated components of the electronic device of the present invention may be implemented into one or more parts, and the names of the corresponding components may be changed depending on the type of the electronic device. The electronic device of the present invention includes at least one of the aforementioned components with omission or addition of some components. The components of the electronic device of the present invention may be combined selectively into an entity to perform the functions of the components in the same manner as before the combination.

The term “module” according to the embodiments of the invention, includes but is not limited to, a unit of software, hardware, and firmware or any combination thereof. The term “module” may be used interchangeably with the terms “unit,” “logic,” “logical block,” “component,” or “circuit.” The term “module” may denote a smallest unit of component or a part thereof. The term “module” may be the smallest unit of performing at least one function or a part thereof. A module may be implemented mechanically or electronically. For example, a module includes at least one of Application-Specific Integrated Circuit (ASIC) chip, Field-Programmable Gate Arrays (FPGAs), and Programmable-Logic Device known or to be developed for certain operations.

According to embodiments of the present invention, the devices (e.g. modules or their functions) or methods may be implemented by computer program instructions stored in a computer-readable storage medium. When the instructions are executed by at least one processor (e.g. processor 120), the at least one processor may execute the functions corresponding to the instructions. The computer-readable storage medium may be the memory 130. At least a part of the programing module may be implemented (e.g. executed) by the processor 120. At least part of the programing module includes modules, programs, routines, sets of instructions, and processes for executing the at least one function.

The computer-readable storage medium includes magnetic media such as a floppy disk and a magnetic tape, optical media including a Compact Disc (CD) ROM and a Digital Video Disc (DVD) ROM, a magneto-optical media such as a floptical disk, and the hardware device designed for storing and executing program commands such as ROM, RAM, and flash memory. The programs commands include the language code executable by computers using the interpreter as well as the machine language codes created by a compiler. The aforementioned hardware device can be implemented with one or more software modules for executing the operations of embodiments of the present invention.

The module or programming module of the present invention includes at least one of the aforementioned components with omission of some components or addition of other components. The operations of the modules, programming modules, or other components may be executed in series, in parallel, recursively, or heuristically. Some operations may be executed in a different order, omitted, or extended with other operations.

According to embodiments, in a computer-readable storage medium which records thereon commands, the commands are defined to enable at least one processor to perform at least one operation when being executed by the processor. The operation includes recognizing a request for displaying the size-adjusted screen, displaying the size-adjusted screen on one region of the display unit in response to the request, and displaying the auxiliary screen outside region.

While the present invention has been particularly illustrated and described with reference to certain embodiments thereof, it will be understood by those skilled in the art that changes in form and details may be made therein without departing from the spirit and scope of the present invention as defined by the appended claims.

What is claimed is:

1. A screen display method of an electronic device, comprising:
recognizing a request for displaying a size-adjusted screen; and
displaying the size-adjusted screen on one region of a display unit in response to the request, and displaying an auxiliary screen on an outside region of the size-adjusted screen, the outside region being outside of a perimeter of the size-adjusted screen.

2. The method of claim 1, wherein recognizing the request includes at least one of:
recognizing an occurrence of a predefined user event as the request for displaying the size-adjusted screen; and
recognizing an occurrence of a communication event or a predefined screen change event in a full screen display state.

3. The method of claim 1, wherein the auxiliary screen includes an outer display bar and a menu area which display at least one of a contact list, an application list, and a notification in response to a selection by a user,
wherein the outer display bar is displayed adjacent to a part of the size-adjusted screen, and
wherein the menu area is displayed as a fixed area on a part of a full screen.

4. The method of claim 3, wherein the menu area further displays the application according to one of a higher frequency of use, whether a display is set by the user, whether an application executed in the size-adjusted screen is linked to the application in the menu area, or whether a category of the application is identical to a category of the application executed in the size-adjusted screen.

5. The method of claim 1, wherein displaying the size-adjusted screen includes displaying direction information indicating a direction of a detected external target on a first part of the outside region, the first part facing the external target, and displaying the size-adjusted screen on a second part of the outside region, the second part being different than the first part.

6. The method of claim 1, wherein displaying the size-adjusted screen includes displaying on the outside region an application execution screen which displays one of a user-selected application or a specific application associated with an application executed on the size-adjusted screen, and
wherein the application displayed on the outside region is displayed differently than the application executed on the size-adjusted screen in at least one of scale and content type.

7. The method of claim 1, wherein displaying the size-adjusted screen includes displaying a peripheral device allowing a key input on the outside region, and
wherein when the peripheral device is displayed on the outside region, the peripheral device is recognized as being connected to the electronic device.

8. A screen display apparatus of an electronic device, comprising:
a display unit configured to display a size-adjusted screen changed from a full screen of the electronic device and to display an auxiliary screen in an outside region of the size-adjusted screen; and
a control unit configured to recognize a request for displaying the size-adjusted screen and, based on the request, to control the display unit to display the size-adjusted screen and the auxiliary screen.

9. The apparatus of claim 8, wherein the control unit is further configured to determine, as the request for displaying the size-adjusted screen, an occurrence of at least one of a predefined user event and a communication event or a predefined screen change event in a full screen display state.

10. The apparatus of claim 8, wherein the control unit is further configured to control displaying, as the auxiliary screen, an outer display bar and a menu area which display at least one of a contact list, an application list, and a notification in response to a selection by a user, displaying the outer display bar adjacent to a part of the size-adjusted screen, and displaying the menu area as a fixed area on a part of the full screen.

11. The apparatus of claim 10, wherein the menu area displays the application according to one of a higher frequency of use, whether the display is set by the user, whether an application executed in the size-adjusted screen is linked, or whether a category of the application is identical to a category of the application executed in the size-adjusted screen.

12. The apparatus of claim 8, wherein the control unit is further configured to control displaying direction information indicating a direction of a detected external target on a first part of the outside region, the first part facing the external target, and to control displaying the size-adjusted screen on a second part of the outside region, the second part being different than the first part.

13. The apparatus of claim 8, wherein the control unit is further configured to control displaying on the outside region an application execution screen which displays one of a user-selected application or a specific application associated with an application executed on the size-adjusted screen, and to control the application displayed on the outside region to be displayed differently than the application executed on the size-adjusted screen in at least one of scale and content type.

14. The apparatus of claim 8, wherein the control unit is further configured to control displaying a peripheral device allowing a key input on the outside region, and to recognize, when the peripheral device is displayed on the outside region, that the peripheral device is connected to the electronic device.

15. A non-transitory computer-readable storage medium having recorded thereon a program for executing a screen display method of an electronic device, comprising:
recognizing a request for displaying a size-adjusted screen; and
displaying the size-adjusted screen on one region of a display unit in response to the request, and displaying an auxiliary screen on an outside region of the size-adjusted screen, the outside region being outside of a perimeter of the size-adjusted screen.
